(19) United States
(12) Patent Application Publication
(10) Pub. No.: US 2017/0059116 A1
(43) Pub. Date: Mar. 2, 2017

(54) LED ARRAY WITHIN ASYMMETRIC CAVITY HAVING REFLECTIVE AND NON-REFLECTIVE REGIONS

(71) Applicants: Min Huang, Hillsboro, NH (US); Lawrence M. Rice, Hillsboro, NH (US)

(72) Inventors: Min Huang, Hillsboro, NH (US); Lawrence M. Rice, Hillsboro, NH (US)

(73) Assignee: OSRAM SYLVANIA INC., Danvers, MA (US)

(21) Appl. No.: 14/840,456

(22) Filed: Aug. 31, 2015

(51) Int. Cl. F21S 8/10

(52) U.S. Cl. CPC F21S 48/31; F21S 48/1154; F21S 48/1376; F21S 48/145; F21Y 2101/02; F21Y 2103/003

(57) ABSTRACT

A packaged light emitting device 100 that allows enhanced light cutoff in lighting applications to better control glare and optimize lumen output. Packaged device 100 includes an LED array 4 in cavity 32 whose inner wall includes both a reflective wall portion 34 and a non-reflective wall portion 36 to increase output of useful light while mitigating reflection of light that can cause glare. An array 4, preferably linear, of light-emitting diodes 3 is formed on printed circuit board (PCB) 1, and surrounded by wall 30 which bounds cavity 32. A first circuit board portion 20 of PCB upper surface 2 enclosed within wall 30 disposed forward of LED array 4 and adjoining non-reflective wall portion 36 is non-reflective, such as being black. A second circuit board portion 22 is reflective, such as being silvered. Packaged device 100 is suited for automotive headlights and fog lights.

### TECHNICAL FIELD

The present disclosure relates to light emitting devices that enhance light cutoff to prevent a significant or otherwise distracting amount of light from being cast into preceding or oncoming cars. More particularly, the present disclosure relates to automotive chip-on-board (COB) light emitting diode (LED) sources on a printed circuit board (PCB) in a recess or cavity whose inner wall that includes both a reflective, sloped wall region and a non-reflective, vertical straight wall region to increase the output of useful light while eliminating or otherwise mitigating the reflection of light that can cause glare.

### BACKGROUND

LED devices including an LED chip that is mounted onto a flat substrate and housed at a floor of a reflective cavity are known. These devices may be generally referred to as “chip on board” (COB) devices.

The following are known: U.S. Pat. No. 7,982,403 (Hohl-AbiChedid); U.S. Pat. No. 7,968,900 (Hussell); U.S. Pat. No. 7,719,021 (Harrah); U.S. Pat. No. 7,183,706 (Ellens); U.S. Pat. No. 6,459,130 (Arndt); Des. U.S. Pat. No. 632,659 (Hsieh); and Pat. Pub. US 2004/0184270 (Halter). While light engines for general lighting purposes are known having LED chips mounted in a cavity whose internal surfaces are reflective, such an arrangement is not suitable for use in an automotive low beam headlamp or fog lamp because it is understood to generate too much glare.

Known in U.S. Pat. No. 8,247,827 (Helbing), referring to col. 4, line 20, is a dam 106 whose entire extent around LED 202 is either entirely a reflective dam 206 or a transparent (or “clear”) dam 208, but not both reflective and transparent portions simultaneously. In the case where dam 106 is entirely a reflective dam 206, it is made of a reflective material such as being opaque white formed by titanium dioxide filler in an epoxy or silicone. In the case of dam 106 being entirely a clear or transparent dam 208 it is made of epoxy or silicone without filler. A side-by-side comparison at FIG. 2 shows a dam 106 that is reflective (206) generates a narrow beam pattern 218, in contrast to a dam 102 that is transparent (208) which generates a wider beam 222. While the dam 106 shows a side comparison akin to a “split screen” view which may at first glance misleadingly suggest the dam contains both reflective and transparent portions, one of skill in the art understands from the entirety of Helbing's disclosure in context, e.g. at column 5, lines 20-35 and the overall two different radiation patterns 218, 222, that the entire dam 106 is either opaque reflective in its entirety or transparent in its entirety.

Various dams and encapsulent arrangements for LEDs are known in: U.S. Pat. No. 6,897,490 (Brunner); U.S. Pat. No. 8,044,128 (Sawada); U.S. Pat. No. 8,835,952 (Andrews); U.S. Pat. No. 6,489,637 (Sakamoto); U.S. Pat. No. 7,952,115 (Loh); U.S. Pat. No. 7,834,375 (Andrews); U.S. Pat. No. 7,365,371 (Andrews); U.S. Pat. No. 8,492,790 (Lin); U.S. Pat. No. 8,536,592 (Chang); U.S. Pat. No. 8,536,593 (Lo); and US Pat. Pubs. 2013/0312906 (Shiobara); 2013/0207130 (Reiherzer); 2013/0154130 (Peil); 2003/0062518 (Auch); 2008/0099139 (Miyoshi); 2012/0193647 (Andrews); 2005/0051782 (Negley); and in PCT Int'l Application WO 2008/046583 (Schrank). A circuit board is shown in U.S. Pat. No. 7,201,497 (Weaver).

### BRIEF DESCRIPTION OF THE DRAWINGS

Reference should be made to the following detailed description, read in conjunction with the following figures, wherein like numerals represent like parts:

FIG. 1 schematically illustrates one example packaged light emitting device 100 including a circuit board with a chip on board (COB) configuration according to the present disclosure;

FIG. 2 schematically illustrates another example of the packaged device of FIG. 1, and illustrates example reflective and non-reflective features thereof in more detail, in accordance with an embodiment of the present disclosure;

FIG. 3 shows another example of the packaged device of FIG. 1, and illustrates a cavity 32 having a racetrack shape, in accordance with an embodiment of the present disclosure;

FIG. 4 shows a longitudinal cross-sectional view through reflective wall 34 and LED array 4 of FIG. 1;

FIG. 5 shows a longitudinal cross-sectional view through non-reflective wall 36 of FIG. 1;

FIG. 6 shows an example lateral cross-sectional view of the packaged device of FIG. 1, in accordance with an embodiment of the present disclosure;

FIG. 7 schematically illustrates another example of the packaged device of

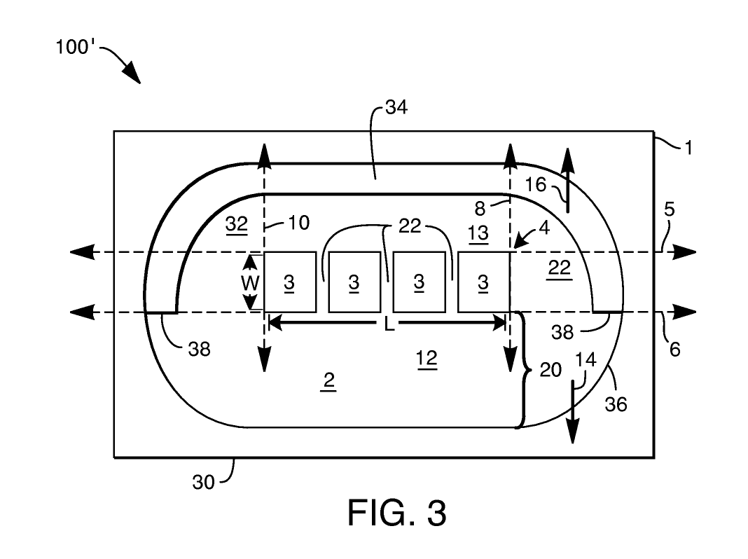

FIG. 3 including reflective and non-reflective regions thereof;

FIG. 8 shows a simulated low beam hot spot according to a prior art packaged device;

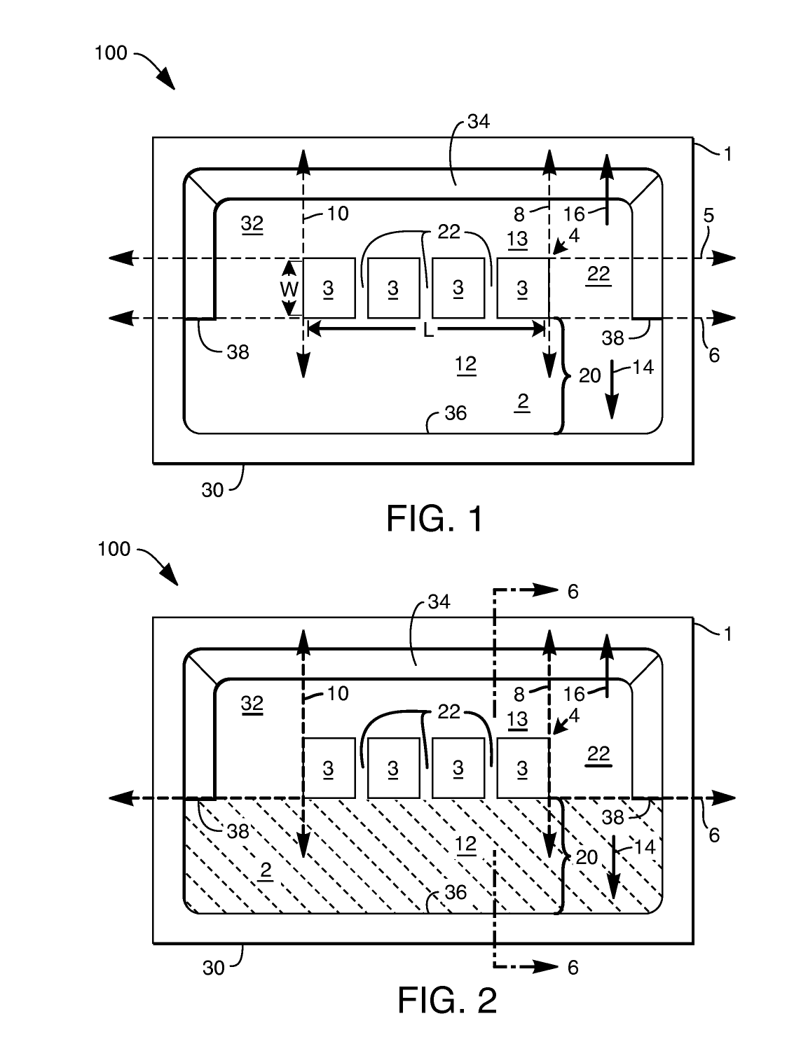

FIG. 9 shows a simulated low beam hot spot according to an embodiment of the present disclosure similar to packaged device shown in FIG. 1;

FIG. 10 shows an example reflector assembly having active optics and including a packaged device with reflective and non-reflective portions, in accordance with an embodiment of this disclosure;

FIG. 11 shows an example total internal reflector assembly including a packaged device having reflective and non-reflective portions, in accordance with an embodiment of this disclosure;

FIG. 12 shows an example lateral cross-sectional view showing an LED array 4 displaced from a midpoint, in accordance with an alternate embodiment of the present disclosure;

FIG. 13 shows a plot of simulated output from a packaged device of a present embodiment as a function of displacement of LED array 4 from a midpoint; and

FIG. 14 shows a perspective view of device 100 of FIG. 1.

For a thorough understanding of the present disclosure, reference is made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION INCLUDING BEST MODE OF A PREFERRED EMBODIMENT

The present disclosure provides a packaged light emitting device that allows enhanced light cutoff in lighting applications that seek to control glare and optimize or otherwise improve lumen output during low-beam generation. To provide the enhanced light cutoff, the packaged device includes both slanted, reflective wall regions and vertical, non-reflective wall regions to increase the output of useful light while also eliminating or otherwise mitigating the reflection of light that can cause glare. The packaged light emitting device is formed by an array of light-emitting diodes (LEDs) disposed on a generally flat substrate, such as a printed circuit board (PCB), and surrounded by a wall to define a cavity surrounding the array of LEDs. This arrangement is generally referred to as chip-on-board (COB), which has seen a steady rise in popularity in a host of applications. For instance, COB is particularly well suited in automotive lighting applications including headlights and fog lights. Thus the packaged device may be used in a host of applications which make use of LED COB devices including, for example, motor vehicles, highway lighting, street lighting, and other applications that benefit from wide-area light emitters.

As referred to herein, the term reflective generally refers to a surface that reflects a majority of incident visible light. On the other hand, a non-reflective surface generally refers to a surface that reflects relatively less incident visible light than the reflective surface through, for example, absorption, diffraction, or other properties that mitigate reflection of light. These terms are intended to include common, ordinary meaning, but should not be construed as necessarily an exact reflectivity. In any event, and for the purpose of providing some specific examples, the minimum reflectivity of a “reflective” surface includes a reflectivity value of at least 70% for visible wavelengths, if not more. In contrast, the maximum reflectivity value of a “non-reflective” surface is 10%, with a preference towards the reflectivity being between 1% and 9%.

It should be appreciated that a non-transparent surface is functionally different than a transparent surface in the context of light beam optics. That is, non-transparent surfaces can absorb photons and generally do not spread a light beam. In contrast, a transparent surface does spread a light beam. A surface made of a transparent material, such as some ceramics, can function as a non-reflective surface, and while an opaque, black surface (such as one coated with carbon black) can be a non-reflective surface, the resulting light beams produced therefrom, respectively, have different beam patterns.

In any event, the packaged device disclosed herein includes part of its surface being non-reflective (e.g., black), and the remaining portion being reflective (e.g., silvered, or white). This is to maximize or otherwise increase the output of useful light and to minimize or otherwise decrease the reflection of the light that otherwise causes glare. The silvered or white area, while capturing photons that would otherwise be wasted, produces light at a lower intensity than the main image of a light beam. In order to effectively produce a low beam, high intensity is desirable close to the light/dark cutoff with little or no spillover of lower intensity. To provide this balance, there is a non-reflective (e.g., black) region along a top or bottom portion along the long-side of the packaged device that produces the light/dark cutoff, and a reflective (e.g., silvered, or white) area on the opposite side to recover photons that would otherwise be wasted. In some cases, the line of demarcation between reflective and non-reflective areas is at the base, or top, as the case may be, of the LED devices fixedly attached to an upper surface of the packaged device. Thus the ratio of surface area that is reflective versus non-reflective is configurable, depending on a desired beam configuration.

Aspects and embodiments disclosed herein manifest an appreciation that an entirely reflective wall, such as a white or aluminized wall, produces high luminous intensity in a produced beam. In addition, an entirely non-reflective wall, such as a black wall, reduces glare. Thus, an embodiment disclosed herein includes a wall having both a reflective region and a non-reflective region to provide enhanced light cutoff (e.g., to reduce glare) and optimize or otherwise improve lumen output during low-beam generation.

Turning now to FIG. 1, the packaged device 100 electrically couples a linear array 4 of LEDs 3 to a lighting controller (not shown), such as provided in a motor vehicle headlamp, to provide controllable illumination. Note that while the specific examples provided herein reference motor vehicle lighting, the disclosure is not so limited and is merely an exemplary application.

In one aspect, the packaged device 100 includes a circuit board 1 comprising, for example, a printed circuit board (PCB) or other suitable substrate. For instance, the circuit board 1 can include a dielectric material such as, for example, glass fiber reinforced (fiberglass) resin, or a metal-core printed circuit board (MCPCB) or a ceramic substrate or ceramic heatsink, just to name a few. As shown, the circuit board 1 includes a circuit board upper surface 2, and a circuit board bottom surface (not shown) opposing the circuit board upper surface 2.

The circuit board 1 includes a plurality of solid-state light-emitting sources, such as light-emitting diodes (LEDs) 3, fixedly coupled to the circuit board upper surface 2, and forming an array 4, preferably a linear array of LEDs 4. The LEDs 3 may be attached via a feature of the circuit board 1, such as a ceramic sub-mount, or other suitable feature integrated or otherwise attached to the circuit board 1. The LEDs 3 are adjacent one another, and optionally and preferably arranged in a linear array 4. The LED linear array 4 is disposed along a first (forward) major long axis 6 that extends tangent to a long side of the linear array of LEDs 4 on a laterally forward direction 14 of the array. If the arrangement of LEDs 3 diverges from being a linear array 4, first long axis 6 is considered constructed tangent the forewardmost LED(s) in direction 14. In addition, the linear array of LEDs 4 also further define a rear major long axis 5 that also extends tangent to a long side of the linear array of LEDs 4 that is in parallel with the first major long axis 6. The linear array of LEDs 4 further defines two opposed lateral sides 8 and 10, respectively.

The packaged device 100 is not necessarily limited to four LEDs 3, as shown. For example, the packaged device 100 can include three (3), or more than four (4), LEDs 3, depending on a desired configuration. Moreover, while the linear array of LEDs 4 is shown in a generally center position of the packaged device 100, other locations will be apparent in light of this disclosure. The linear array of LEDs 4 can include uniform spacing between LEDs 3, or non-uniform spacing. Such spacing can include, for example, 1 millimeter or more or less, typically 0.1 mm in automotive lamps. The length L of the linear array of LEDs 4 can vary depending on, for instance, the size of each of the LEDs 3, the particular number of LEDs 3 within the linear array of LEDs 4, and desired component spacing configuration (e.g., uniform spacing, or non-uniform spacing). Likewise, the width W of the linear array of LEDs 4 can vary depending on similar factors, including the number of rows of LEDs 4, for example.

As shown in FIG. 6 (not to scale), upper surface 2 of circuit board 1 is defined to be within cavity 32 surrounding linear array 4 of LEDs 3. In some embodiments cavity 32 defines as well an encapsulation-receiving region 32 that is configured, in the shape of a well or dam, to receive an encapsulant 40 (not shown), such as silicone, and, if an encapsulant is used, then to contain it while such liquid encapsulant solidifies. In some embodiments, cavity 32 is defined in a ceramic substrate by forming wall 30 and circuit board 1 of a ceramic material, which, as is known in the art, is an electrical insulator and is then masked and has deposited thereon electrically conductive traces to form circuitry connecting to LEDs 3. Suitable ceramics are aluminum oxide (Al2O3) or aluminum nitride (AlN). Whether wall 30 is formed integral with circuit board 1 and circuit board upper surface 2, such as by being formed as a ceramic heatsink, or whether wall 30 is a separate component mounted onto a traditional circuit board 1 that is formed of FR-4 or MC-PCB material, is immaterial, and the description herein embraces both techniques. A wall 30 is disposed on the circuit board upper surface 2, with the wall 30 surrounding, in spaced relation, the linear array of LEDs 4, and on an inner-region thereof, the cavity 32. If wall 30 is formed as a separate component from circuit board 1, then wall 30 can be fixedly attached via a sealant or other suitable fastener that provides adhesion between wall 30 and the circuit board upper surface 2. If formed of ceramic material, wall 30 and circuit board upper surface 2 are advantageously integrally formed of the same piece of material. Wall 30 can have a thickness of at least 0.1 millimeters, although other thicknesses are also within the scope of this disclosure.

Referring to FIG. 14 showing a perspective view of the embodiment of FIGS. 1, 2 and 6, and as discussed below with regard to FIG. 6, wall 30 includes an inwardly facing wall 35. Inwardly facing wall 35 has a sloped region along the portion of wall 30 that forms reflective wall portion 34; inwardly facing wall 35 also has a straight vertical region along the portion of wall 30 that defines non-reflective wall portion 36. The sloped, reflective wall portion 34 is bounded at terminal ends 38 and in some examples is U-shaped.

Within the cavity 32, the circuit board upper surface 2 further includes a first circuit board portion 20, with the first circuit board portion 20 located in a forward region 12 disposed in the laterally forward direction 14 of the first major long axis 6. As discussed below in greater detail, the first circuit board portion 20 is a non-reflective surface. The non-reflective first circuit board portion 20 is preferably generally flat. The first circuit board portion 20 has a surface that is generally a black hue. Some such example materials providing such a non-reflective surface are discussed further below.

Also within cavity 32 at the base or floor thereof, the circuit board 1 further includes a second circuit board portion 22 of the circuit board upper surface 2, with the second circuit board portion 22 located in a rear region 13 disposed in the laterally rearward direction 16. The second circuit board portion 22 of the circuit board upper surface 2 occupies an area of the base of cavity 32 less the space occupied by the first circuit board portion 20 of within cavity 32. As also discussed in greater detail below, the second circuit board portion 22 is a reflective surface. The reflective second circuit board portion 22 is preferably generally flat. Some such example materials providing such a reflective surface are discussed further below.

Now referring to FIG. 2, there is an example of the packaged device 100 of FIG. 1 schematically illustrated in further detail. Some features of the packaged device 100 shown in FIG. 2 have been omitted merely for clarity. As shown, the non-reflective first circuit board portion 20 and the reflective second circuit board portion 22 generally conform to and are adjacent to a non-reflective wall portion 36, and a reflective wall portion 34, respectively. To this end, the first circuit board portion 20 includes a black or otherwise non-reflective surface to provide such a non-reflective surface and match or approximate the corresponding non-reflective surface of the non-reflective wall portion 36, as indicated by shading thereon. Similarly, and on the other hand, the second circuit board portion 22 includes a reflective surface (silvered, or white) to match or approximate the corresponding reflective wall portion 34.

As shown, the non-reflective wall portion 36 is a region of wall 30 disposed in the laterally forward direction 14 forward of an intersection of the first major long axis 6 and the wall 30. The non-reflective wall portion 36 and reflective wall portion 34 thus collectively define the entire wall 30. The reflective wall portion 34 occupies a remaining region of the wall 30 and is disposed in a rearward direction 16 behind the first major long axis 6. Reflective wall portion 34 surrounds the two opposed lateral sides 8, 10 and the rear long axis 5 of the linear array of LEDs 4. Forward region 112 of the circuit board upper surface 2 also includes non-reflective qualities, as indicated by shading thereon (FIG. 2). The rearward region 13 of the circuit board upper surface 2 includes the remaining area, and is indicated in FIG. 2 as reflective by an absence of shading.

Thus non-reflective first circuit board portion 20 can include a surface with a reflectivity that is less than or equal to the reflectivity of the non-reflective wall portion 36, and vice-versa. In some cases, this can include the first circuit board portion 20 and the non-reflective wall portion 36 both having a surface with a black hue. A black hue can be achieved by coating a surface with carbon black. Alternatively, circuit board 1 and wall 30 could be formed of aluminum nitride ceramic which is naturally dark brown or black-colored. Similarly, the second circuit board portion 22 can include a surface with a reflectivity that is less than or equal to the reflectivity of the reflective wall portion 36, and vice-versa. However, preferably the reflectivity of surfaces of non-reflective first circuit board portion 20 and non-reflective wall portion 36 are less than the reflectivity of the surfaces of second circuit board portion 22 and reflective wall portion 34.

One or both the reflective wall portion 34 and reflective second circuit board portion 22 can have a surface that is specular reflective or partially non-specular reflective. For example, high reflectivity that is specular can be provided by coating reflective wall portion 34 or second circuit board portion 22, or both of them, with aluminum or silver or gold, any of which produces a surface that appears generally silvery and shiny, with which a reflectivity of 95% is known to be achievable. Alternatively a suitable diffuse (partially non-specular) reflectivity can be provided by a white coating such as titanium dioxide (TiO2). If wall 30 and circuit board 1 are formed of a ceramic block that defines cavity 32 therein, such as of a dark aluminum nitride, then those portions of the ceramic on circuit board upper surface 2 and inwardly facing wall 35 that are to form the reflective surfaces second circuit board portion 22 and reflective wall portion 34 are coated with reflective aluminum or silver, but the non-reflective surfaces forming first circuit board portion 20 and non-reflective wall portion 36 are left uncoated. The exact material selection for reflective and non-reflective wall portions 34 and 36, respectively, and reflective and non-reflective circuit board portions 22 and 20, respectively, is not particularly relevant to the present disclosure, but is important to the extent that the wall 30 have both reflective and non-reflective portions to achieve a desired light cutoff during operation of the packaged device 100.

While the first major long axis 6 shown in FIG. 2 provides a convenient and suitable point for delineating reflective and non-reflective regions, this disclosure is not limited in this regard. For instance, the demarcation between reflective and non-reflective regions may not be defined by a line that runs perpendicular to the the opposed lateral sides 8 and 10 as shown, and instead, may be defined by a generally sloped or diagonal line. Also, such demarcation can occur at a position that is above, or below, the position of the first major long axis 6 shown in FIG. 2 (e.g., located in a position favoring rearward direction 16, or favoring the forward direction 14). Such a position can bisect the linear array 4 of LEDs, or at least occupy a position that cuts through a portion of the linear array 4 of LEDs versus stopping just short of or abutting the LEDs 3, as shown.

To this end, the reflective and non-reflective regions (including corresponding wall 30 portions) may occupy a generally equal area (e,g., 50%/50%) of the circuit board upper surface 2 inside cavity 32 bounded by wall 30, or be split unevenly between the two. For example, the first circuit board portion 20 may occupy 51% to 80%, or more, of the circuit board upper surface 2 bounded by wall 30. In any event, during processing of the packaged device 100, the formation of reflective and non-reflective regions of both of the circuit board upper surface 2 and the wall 30, and the extent of surface space of circuit board 1 consumed thereby, can be configurable depending on a desired configuration.

Referring now to FIG. 3, there is a schematic of a packaged device 100′, which is another example of packaged device 100 of FIG. 1. The packaged device 100 is identical to that of the packaged device 100, except for the wall 30 having an oval or racetrack shape rather than the rectangular shape of FIG. 1. Accordingly, cavity 32 includes a generally rounded boundary end that is defined by wall 30 rather than the square boundary (e.g., right-angle corners) as shown in FIGS. 1-2. As should be appreciated, the shape in top plan view of wall 30 can include other regular such as circular) or irregular geometric shapes, and the present disclosure should not be construed as limited merely to the ones shown. As will also be appreciated in light of this disclosure the absolute size dimensions of wall 30, or relative size dimensions of portions thereof, are not limited to the particular embodiments illustrated herein.

Referring now to FIG. 6, there is a lateral (width-wise) cross-sectional view of the packaged device 100 of FIG. 1 in accordance with an embodiment of the present disclosure. Note that the embodiment shown in FIG. 6 is also applicable to the embodiments of packaged device 100′ shown in FIG. 3. The packaged device 100 can include an encapsulant 40, not shown, disposed above the circuit board upper surface 2 forming a lens. During processing of the COB the encapsulant 40 can be flowed and held in place by a well formed by cavity 32. In particular, containment of the free-flowing encapsulant 40 during process is achieved based on the inwardly facing walls 35 of wall 30 while the encapsulant 40 solidifies. The encapsulant 40 can include silicone, or other suitable material used in COB applications, as should be appreciated. Encapsulant 40 can, depending on surface tension and quantity of encapsulant 40, form an outwardly convex domed upper surface, or, more preferably, form a generally flat upper surface (not shown) that is parallel circuit board 1 and generally tangent to upper regions of both reflective wall portion 34 and non-reflective wall portion 36.

Also shown in the embodiment of FIG. 6 is a wire bond 41 that extends from each LED 3 of the linear array of LEDs 4 of FIG. 1 to the forward direction 14. Although shown as recessed in the circuit board 1, the wire bond 41 can include various configurations to allow a lighting system (e.g., a headlamp) to electrically couple to the packaged device 100. For example, the wire bond 41 can be routed over the wall 30, or on a backside surface 11 of the circuit board 1. In another example, the wire bond 41 can be at least partially routed on the circuit board upper surface 2. In this example, the wire bond 41 may extend through the wall 30 such as through an opening in wall 30. Note that the wire bond 41 may alternatively extend and be routed in the rearward direction 16.

In any event, the wire bond 41 may include or otherwise couple to electrical terminals (not shown) for forming such an electrical connection between a lighting system/assembly and the packaged device 100. These terminals may be located on the backside surface 11 of the circuit board 1, or at a position outside of the cavity 32 adjacent the wall 30. Note that in some cases the wire bond 41 is routed through reflective regions, or alternatively, below the non-reflective regions, to reduce the potential of the wire bond 41 reflecting light incident to its surface in those areas of the packaged device 100 that are provided with a non-reflective surface. Stated more generally, the wire bond 41 is routed in such a way that it does not introduce a reflective surface in an otherwise non-reflective region of the packaged device 100. To this end, numerous routing options for wire bond 41 will be apparent in light of this disclosure.

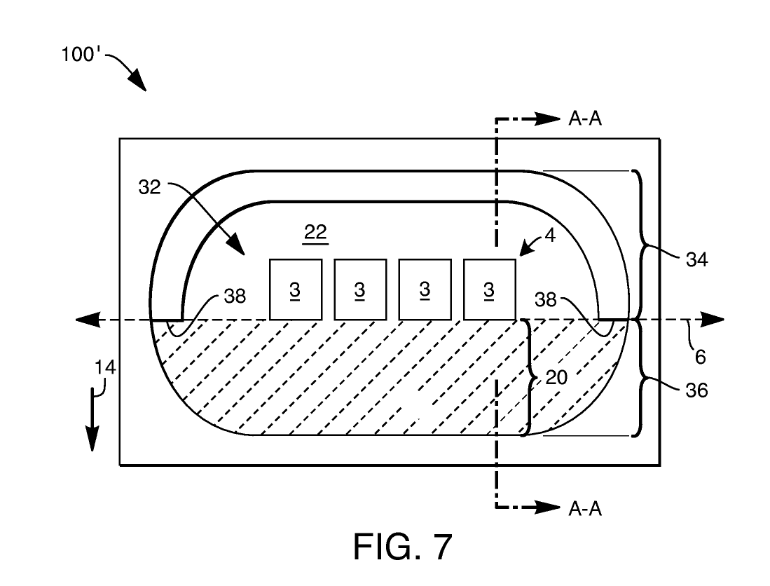

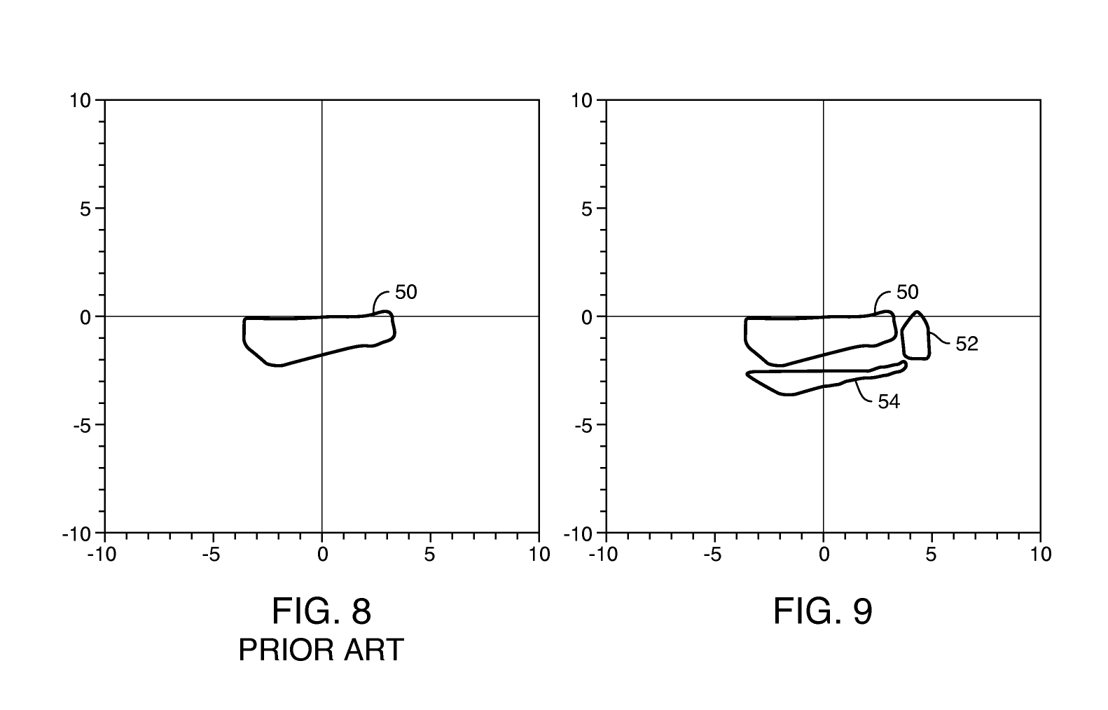

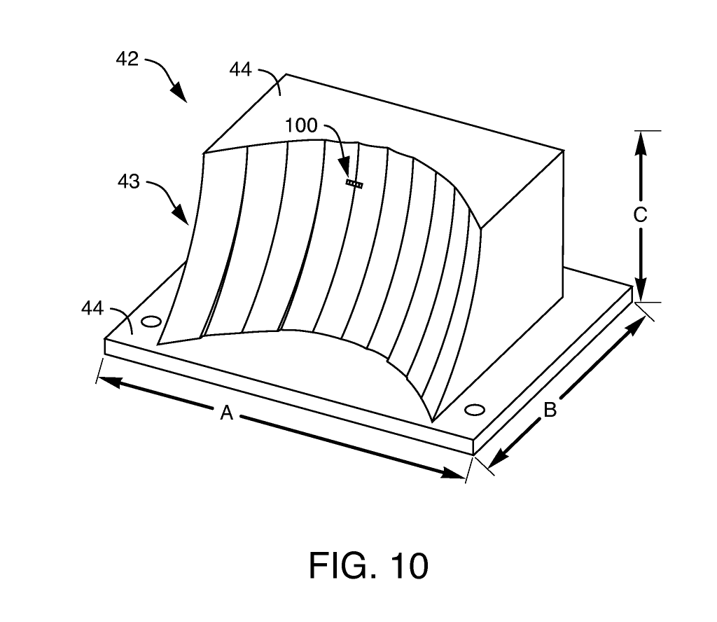

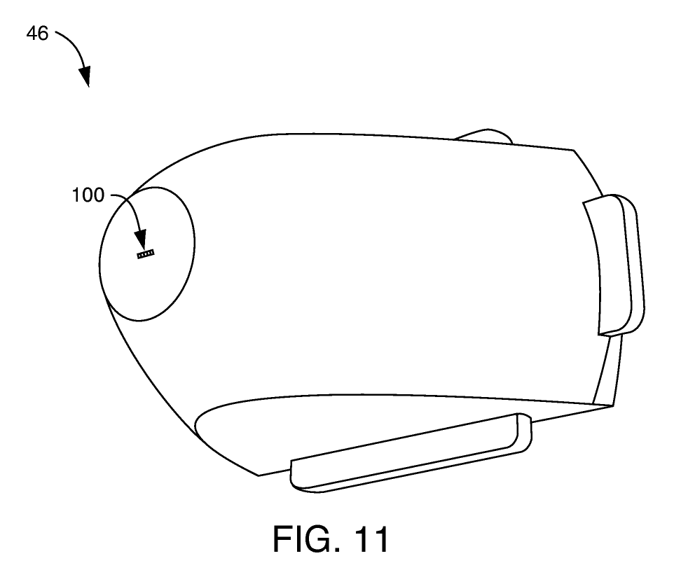

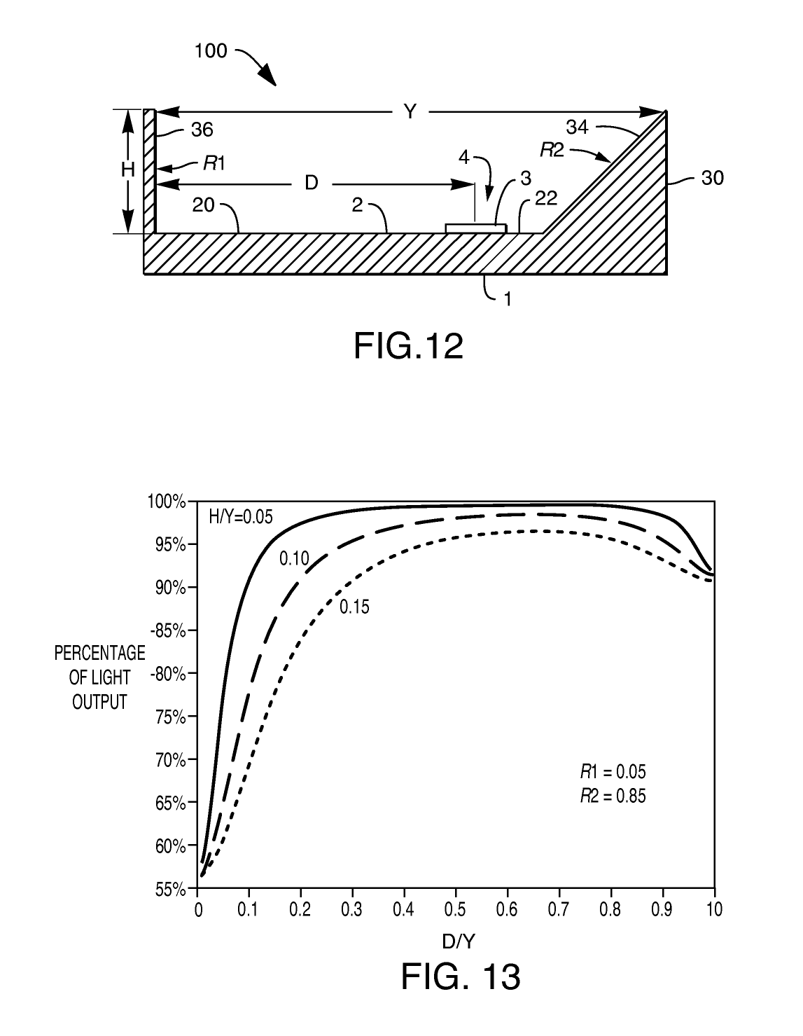

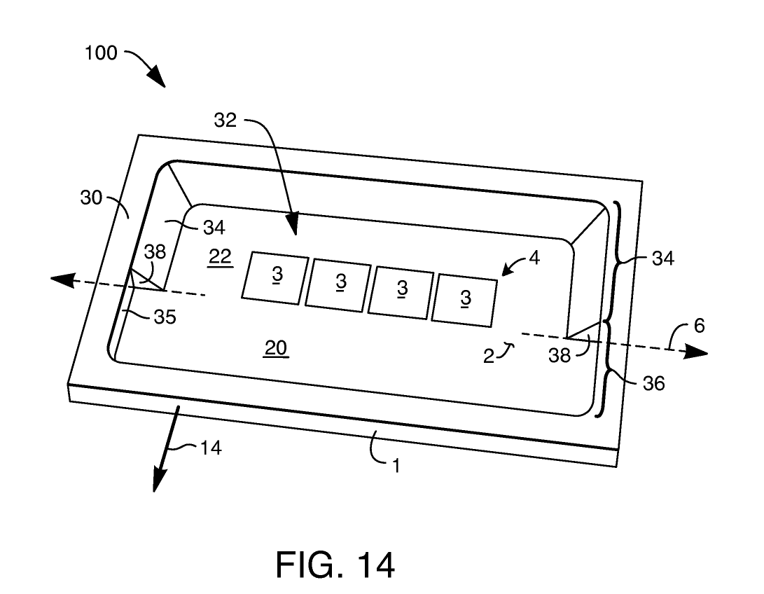

Now referring to FIG. 7, there is a schematic view illustrating the packaged device 100′ of FIG. 3. As shown, the cavity 32 includes first circuit board portion 20 being a non-reflective region, as indicated by shading thereon, and bounded by the non-reflective wall portion 36. In an embodiment, any region of the circuit board 1 positioned in the forward direction 14, including the inwardly facing wall 35 of wall 30, can receive light emitted by the linear array of LEDs 4. For this reason, the first circuit board portion 20 is non-reflective to allow the packaged device 100′ to produce a beam with minimized or otherwise reduced glare. This aids in producing the light/dark cutoff, as previously discussed.

Also as shown, the cavity 32 includes the second circuit board portion 22 being a reflective region, as indicated by an absence of shading thereon, and is bounded by the reflective wall portion 34. The second circuit board portion 22 has a mirrored finish such as an aluminized surface, or alternatively can be white. In any event, this reflective region allows the packaged device 100′ to recover photons that would otherwise be wasted, as previously discussed.

Referring now to FIG. 6, there is a cross-sectional view of the packaged device 100 of FIG. 1 or of FIG. 3, as shown taken along exemplary sectional line 6-6 of FIG. 2. As shown in FIG. 6, the reflective wall portion 34 includes a portion of the inwardly facing wall 35 of wall 30 of cavity 32 that is sloped at angle θ relative to the circuit board 1. It is seen that angle θ is the angle included between the sloped inwardly facing portion of reflective wall portion 34 and circuit board upper surface 2 (in this view, a horizontal projection of circuit board upper surface 2 toward the left of the page). The preferred angle θ is less than 90 degrees, and in particular, at approximately 45 degrees, ±10 degrees, that is, within the range of about 35 degrees to about 55 degrees. It is preferred that only reflective wall portion 34 is sloped at an angle 0 less than 90 degrees, whereas it is preferred that non-reflective wall portion 36 not be sloped relative to circuit board 1 but rather be transverse, preferably substantially perpendicular, to circuit board upper surface 2. As shown, non-reflective wall portion 36 is substantially straight, vertical over an entirety of its wall portion 36 in forward direction 14 laterally forward of first major long axis 6.

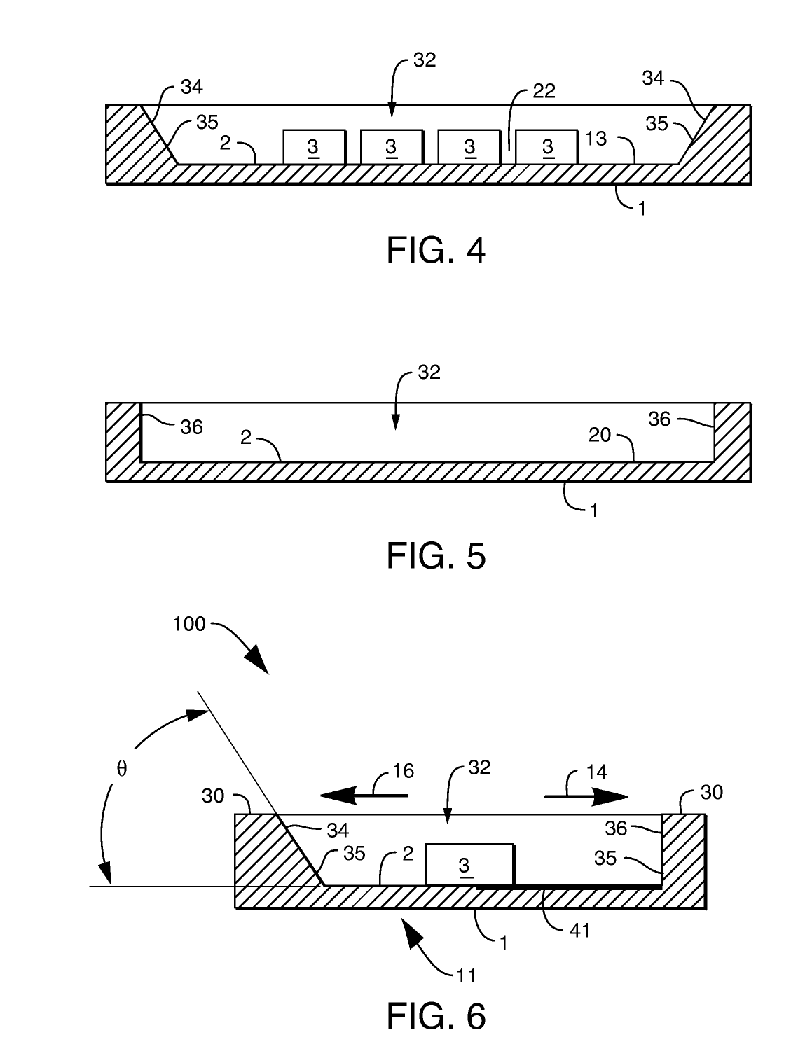

Referring to FIG. 4, there is shown a longitudinal sectional view of the FIG. 1-2 embodiment taken through reflective wall portion 34 and LED array 4. As can be seen, sloped reflective wall portion 34 exhibits along the lateral sides 8, 10 the same included angle θ as shown in FIG. 6. Referring to FIG. 5, there is shown another longitudinal sectional view of the FIG. 1-2 embodiment taken through a portion of wall 30 forward of LED array 4, that is, through non-reflective wall portion 36 forward, in direction 14, of first major long axis 6, and as seen therein straight non-reflective wall portion 36 is transverse to circuit board upper surface 2, preferably perpendicular upper surface 2.

Referring to FIG. 8, there is shown a central hot spot region 50 of a typical automotive headlamp low beam pattern generated by simulation analysis of a linear array of four LEDs in a cavity of the prior art. Such a light engine was for simulation purposes modeled as a linear LED array disposed centrally in a straight-walled rectangular cavity (approximately resembling the rectangular opening shown at FIG. 1 at the uppermost rim of cavity 32 but whose inwardly facing four walls were all straight vertical and not sloped) and whose inwardly facing walls and floor of the cavity were uniformly non-reflective as known in the art. The shape of the central hot spot region 50 is given by a contour line of equal intensity. The hot spot 50 is known in the art as a region of highest luminious flux within the beam, and the hot spot rather than the entire low beam is shown because the hot spot region is the critical portion. The horizontal axis at 0 degrees represents the center of the low beam extended in space. The hot spot is approximately centrally located within the low beam at a region corresponding to 0 degrees (or barely more than 0 degrees) elevation on the vertical axis and extending a small amount laterally along the horizontal axis, within about +/−5 degrees left and right from the vertical axis. Very little or no light should be above the 0 degree horizontal axis; this is in order to avoid glare to oncoming drivers. In contrast, it is permitted to have high luminous intensities vertically below the horizontal axis, i.e. below 0 degrees, since that light would be cast onto the road ahead of the vehicle whose headlamp generates the hot spot and is not considered to cause glare to an oncoming driver.

Referring to FIG. 9, there is shown a hot spot region of an automobile headlamp low beam pattern generated by simulation analysis of a light emitting device of a present embodiment generally in accordance with that shown in FIG. 1 and FIG. 6 herein. The beam pattern produced thereby contains not only a central hot spot region 50 as is obtained from devices known in the art but also a first additional hot spot region 52 and a second additional hot spot region 54. The additional hot spot regions 52 and 54 are shown to cause negligible or no unwanted light vertically above the 0 degree horizontal axis, but that they advantageously represent additional light output in the body of the low beam from light harvested by the reflective areas within cavity 32.

Referring to FIG. 12, there is an optional embodiment in which LED array 4 is closer to reflective wall portion 34 than it is to non-reflective wall portion 36, as described hereinbelow. FIG. 12 shows a lateral cross-sectional view similar to FIG. 6, though viewed from the other direction (i.e. arrowheads opposite “A-A” of FIG. 2) such that non-reflective wall portion 36 is (and thus forward direction 14 would be) to the left of the page and reflective wall portion 34 is (and thus rearward direction 16 would be) to the right of the page. In particular, LED array 4 is closer to the uppermost (along height H direction upwards most distal from circuit board upper surface 2) rim of reflective wall portion 34 than it is to non-reflective wall portion 36. As shown in FIG. 12, reflective wall portion 34 has a higher surface reflectivity R2 than a surface reflectivity R1 of non-reflective wall portion 36. In an exemplary embodiment, reflectivity R1 is 5% (five per cent) for non-reflective wall portion 36 and reflectivity R2 is 85% (eighty-five per cent) for reflective wall portion 34. The LED array 4 is located at the lower floor of cavity 32 on circuit board upper surface 2. Wall 30 rises to a height H above circuit board upper surface 2, such height H exceeding the typical 0.1 mm thickness of an LED 3, and preferably being substantially more than that, sometimes several times that. The longitudinal center of LED array 4 is located a distance D from non-reflective wall portion 36, where distance D is constructed proceeding from non-reflective wall portion 36 heading towards reflective wall portion 34. (A line extending through longitudinal center of LED array 4 would be into the page of FIG. 12 and parallel first major long axis 6). The dimension Y represents a width that spaces reflective wall portion 34 from non-reflective wall portion 36. Width dimension Y is constructed at an upper surface of wall 30 that defines cavity 32; thus Y is constructed between the uppermost regions, which are most distal (height H) above circuit board upper surface 2, of the reflective and non-reflective wall portions 34, 36. The double-arrow-headed dimension line indicating width Y is a location of an imaginary plane parallel to the circuit board upper surface 2. Along width Y, at a midpoint (Y/2) of a line drawn between non-reflective wall portion 36 and reflective wall portion 34, a ratio of D/Y would be 0.5. As shown in FIG. 12, it is preferred that a longitudinal center through LED array 4 is located a distance D from non-reflective wall portion 36 in direction width Y such that a ratio of D/Y is at least 0.5, and more preferably at a distance D that is displaced past the width midpoint Y/2 such that a ratio of D/Y exceeds 0.5.

It is seen, e.g. in FIGS. 1, 6, that packaged device 100 is asymmetric about a longitudinal centerline of cavity 32, since reflective circuit board portion 22 and reflective sloped wall portion 34 are opposite non-reflective circuit board portion 20 and straight vertical wall portion 36, respectively. Additional asymmetry is seen in the embodiment shown in FIG. 12 in that, in width, LED array 4 is displaced from a midpoint of cavity 32.

Referring to FIG. 13, an aspect ratio of a depth (indicated by height H) of cavity 32 to width (indicated by width Y) of cavity 32 is given by the dimensionless parameter H/Y. Exemplary aspect ratios H/Y of some embodiments are 0.05, 0.10 and 0.15 (which can also be expressed as a per cent, i.e. 5%, 10% or 15%). In FIG. 13 there is shown a modeling analysis of an effect of chip location on lumen output. An optimal location is shown with LED array 4 closer to the reflective wall portion 34 which has the higher reflectivity. In FIG. 13 there is shown a plot of percentage of light output plotted against the ratio of distance D to width Y. In a range of representative aspect ratios H/Y of cavity 32 that are of interest, as shown by the maxima on the curve, there is seen to be a range of optimal output, shown by peaks on the curves, in a region of a D/Y ratio of between about 55% to about 75%.

Referring to FIG. 10, there is an example reflector assembly 42 having active optics 43 and electrically coupling to the packaged device 100, in accordance with an embodiment of this disclosure. The example reflector includes a base 44, a body 45, and active optics 43. The reflector assembly 42 includes a length (A) of 120 mm, a width (B) of 120 mm, and a height (C) of 66 mm. To this end, and as shown, the packaged device 100 includes a dimension of 5 mm or less for its relative length, width and height. Note that the packaged device 100 can include additional area by virtue of the circuit board 1, but is omitted merely to show relative position within the reflector assembly 42. In some cases, the active optics 43 are formed by aluminizing a portion of the body 45. The base 44 is non-reflective (e.g., non-aluminized) to avoid reflecting portions of a produced beam. The packaged device 100 is configured to point towards the active optics 43 such that light is emitted directly thereto. This can include the packaged device 100 being positioned relative to the base 44 at an angle of 20 to 30 degrees, for example. The active optics 43 are configured such that a generated beam includes a low-beam with a desired pattern, and with a suitable light/dark cutoff, that can vary based on a desired application.

Referring to FIG. 11, there is an example total internal reflector assembly 46 including the packaged device 100 having reflective and non-reflective portions, in accordance with an embodiment of this disclosure.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, are understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The phrase “comprising” in the claims hereinbelow, or in describing features of an embodiment in the written description hereinabove, includes the case of any such claim or embodiment having only the features recited in the claim or described in that particular embodiment, as well as the case of such claim or embodiment including additional features not recited or listed therein.

An abstract is submitted herewith. It is pointed out that this abstract is being provided to comply with the rule requiring an abstract that will allow examiners and other searchers to quickly ascertain the general subject matter of the technical disclosure. It is submitted with the understanding that it will not be used to interpret or limit the scope or meaning of the claims, as set forth in the rules of the U.S. Patent and Trademark Office.

The following non-limiting reference numerals are used in the specification:

1 circuit board

2 circuit board upper surface

3 LED

4 array of LEDs

5 rear major long axis

6 first (forward) major long axis

8, 10 opposed lateral sides

11 circuit board backside surface

12 forward region

13 rearward region

14 laterally forward direction

16 laterally rearward direction

20 first circuit board portion

22 second circuit board portion

24 first row of LEDs

26 second row of LEDs

30 wall

32 cavity

34 reflective wall portion

35 inwardly facing surface of wall 30

36 non-reflective wall portion

38 terminal end of sloped wall 34

40 encapsulant

41 wire bond

42 a reflector assembly

43 active optics of the reflector assembly 42

44 base of the reflector assembly 42

45 a body of the reflector assembly 42

46 total internal reflector assembly

50 hot spot (conventional, FIG. 8)

52 first additional hot spot

54 second additional hot spot

100 packaged light emitting device

100′ packaged light emitting device

θ angle between face of reflective wall 34 and circuit board

L length of array 4 of LEDs 3

W width of array 4 of LEDS 3

A length of reflector assembly 42

B width of reflector assembly 42

C height of reflector assembly 42

H height (depth) of cavity 32

Y width of cavity 32

D distance from non-reflective wall 36

R1 first reflectivity value of non-reflective wall 36

R2 second reflectivity value of reflective wall 34

What is claimed is:

1. A packaged light emitting device (100) comprising:
a planar circuit board (1) having an upper surface (2);
a plurality of light-emitting diodes (LEDs) (3) coupled to the circuit board upper surface (2) and arrayed in an LED array (4), said array (4) defining a first major long axis (6) extending tangent to a long side of the array (4) on a laterally forward direction (14) of the array, said array further defining two opposed lateral sides (8, 10);
a wall (30) disposed on the circuit board (1) and surrounding, in spaced relation, the LED array (4), the wall (30) bounding, on an inner region thereof, a cavity (32);
a first circuit board portion (20) being the circuit board upper surface (2) disposed within the cavity (32) and located in a forward region (12) disposed in the laterally forward direction (14) of the first major long axis (6), wherein the first circuit board portion (20) is non-reflective;
a second circuit board portion (22) being the portion of the circuit board upper surface (2) within the cavity (32) less the first circuit board portion (20), wherein the second circuit board portion (22) is reflective;
the wall (30) defining a reflective wall portion (34) and a non-reflective wall portion (36), the reflective wall portion (34) and the non-reflective wall portion (36) collectively defining an entirety of the wall (30);
the non-reflective wall portion (36) being a region of the wall (30) disposed in the laterally forward direction (14) forward of an intersection of the first major long axis (6) and the wall (30);
the reflective wall portion (34) occupying a remainder region of the wall (30) and disposed in a rearward direction (16) behind the first major long axis (6);
wherein the non-reflective wall portion (34) is transverse to the planar circuit board (1); and
wherein an inwardly facing wall (35) of the reflective wall portion (34) that faces the array (4) defines an included angle (θ) relative the circuit board upper surface (2) that is less than 90 degrees.

2. The packaged light emitting device (100) of claim 1, wherein the included angle (θ) is within a range of about 35 degrees to about 55 degrees.

3. The packaged light emitting device (100) of claim 2, wherein the included angle (θ) is about 45 degrees.

4. The packaged light emitting device (100) of claim 1, wherein
the non-reflective first circuit board portion (20) includes a reflectivity value of not more than 10%;
the non-reflective wall portion (36) includes a reflectivity value of not more than 10%;
the reflective second circuit board portion (22) includes a reflectivity value equal to or greater than 70%; and
the reflective wall portion (34) includes a reflectivity value equal to or greater than 70%.

5. The packaged light emitting device (100) of claim 1, wherein the reflective wall portion (34) surrounds the two opposed lateral sides (8, 10) and a rear long major axis (5) of the array (4).

6. The packaged light emitting device (100) of claim 1, wherein the first circuit board portion (20) is black.

7. The packaged light emitting device (100) of claim 1, wherein the second circuit board portion (22) is specular reflective.

8. The packaged light emitting device (100) of claim 6, wherein the second circuit board portion (22) is specular reflective.

9. The packaged light emitting device (100) of claim 1, wherein the non-reflective wall portion (36) is black.

10. The packaged light emitting device (100) of claim 1, wherein the reflective wall portion (34) is specular reflective.

11. The packaged light emitting device (100) of claim 1, wherein
the first circuit board portion (20) is black;
the second circuit board portion (22) is specular reflective;
the reflective wall portion (34) is specular reflective; and
the non-reflective wall portion (36) is black.

12. The packaged light emitting device (100) of claim 1, wherein the LED array (4) is a linear array.

13. The packaged light emitting device (100) of claim 1, wherein the wall (30) is formed of a ceramics material.

14. The packaged light emitting device (100) of claim 1, wherein at least one of the second circuit board portion (22) and the reflective wall portion (34) is coated with a reflective metallic material.

15. The packaged light emitting device (100) of claim 1, wherein at least one of the first circuit board portion (20) and the non-reflective wall portion (36) is coated with carbon black.

16. The packaged light emitting device (100) of claim 1, wherein, as seen in cross section transverse to the first major long axis (6) and projected onto a plane parallel the circuit board upper surface (2), a longitudinal center through the LED array (4) is located a distance (D) from the non-reflective wall portion (36) in a direction towards the reflective wall portion (34) at least as far as a midpoint on a line drawn between the non-reflective wall portion (36) and the reflective wall portion (34) at respective uppermost regions thereof most distal (H) from circuit board upper surface (2).

17. The packaged light emitting device (100) of claim 16, wherein the longitudinal center through the LED array (4) is located further than the midpoint in the direction towards the reflective wall portion (34).

18. The packaged light emitting device (100) of claim 1, wherein the cavity (32) defines, as seen at an upper surface of said wall (30) spaced at a height H above circuit board upper surface (2) and in a direction transverse the first major long axis (6), a width Y spacing the reflective wall portion (34) from the non-reflective wall portion (36), wherein a longitudinal centerline through the LED array (4) is spaced from the non-reflective wall portion (36) by a distance D, and wherein a ratio D/Y is between about 0.55 and about 0.75.

19. The packaged light emitting device (100) of claim 1, wherein the non-reflective wall portion (34) is generally perpendicular to the planar circuit board (1).

20. A reflector assembly (45) comprising the packaged light emitting device (100) of claim 1.
